(19) United States
(12) Patent Application Publication
(10) Pub. No.: US 2004/0127201 A1
(43) Pub. Date: Jul. 1, 2004

(54) Cellular telephone having TV reproduction functions

(76) Inventors: Ken Takayama, Kanagawa (JP); Tomohiro Iwanaga, Tokyo (JP)

Correspondence Address: RABIN & Berdo, PC, 1101 14TH STREET, NW, SUITE 500, WASHINGTON, DC, 20005, US

(21) Appl. No.: 10/648,782

(22) Filed: Aug. 27, 2003

(30) Foreign Application Priority Data
Aug. 28, 2002 (JP) 248290/2002

(51) Int. Cl. H04N 5/445

(52) U.S. Cl. 455/414.1; 455/550.1; 348/566

(57) ABSTRACT

A cellular telephone has a function of reproducing image signals and/or sound signals, corresponding to execution of a karaoke function and/or a game function. The cellular phone has conversion means for converting the image signals and/or the sound signals into TV broadcasting signals, and transmission means for transmitting the TV broadcasting signals to a TV receiver.

### BACKGROUND OF THE INVENTION

The invention relates to a cellular telephone having add-on functions including a karaoke (singing to the accompaniment of taped music) function.

In the past, a karaoke reproduction set has been needed for playing karaoke music (song music for singing songs to the accompaniment of taped music), however, due to recent trends towards higher sound quality of the sound source of call-in melodies for cellular telephones, and a function which has since been acquired by the cellular telephones to show images and texts on a display thereof, it has since become possible to play karaoke music with the cellular telephones. Also, it has since become possible to download karaoke musical piece data from karaoke musical piece distribution servers connected to the public network or over the Internet.

In “Portable Viewing and Listening System of Selected Music” disclosed in JP, H11-164058, A, there is shown an embodiment of the invention wherein musical piece data of a desired musical piece is downloaded from a karaoke musical piece distribution server by use of a cellular telephone to reproduce the musical piece data, and to show a text along with images contained therein on a display of the cellular telephone at the same time, thereby enabling the karaoke function to be utilized.

With such an embodiment as described, however, images and texts can be displayed only on a small screen due to limitations to the size of a display mounted in the cellular telephone, so that a player is compelled to sing to the accompaniment with a karaoke set while watching small letters. Furthermore, due to limitations to the size of a karaoke set cabinet, only a speaker small in size can be mounted in a karaoke set, thus presenting a problem that karaoke music suitable for practical application cannot be reproduced. In this respect, “Cellular Telephone with Built-in Video Circuit” as disclosed in JP, 2001-345894, A, shows an embodiment of the invention wherein display on the screen of a cellular telephone can be shown on a TV receiver by providing the cellular telephone with video circuits, transmitter circuits, or video output terminals. There is not shown, however, any embodiment enabling diverse data such as musical piece data, acoustic data, etc., necessary for utilization of karaoke music or game software, to be reproduced in practical reproduction environments.

### SUMMARY OF THE INVENTION

The invention may provide a cellular telephone capable of offering practical reproduction environments in utilization of add-on functions such as a karaoke function and so forth.

A cellular telephone according to the invention is a cellular telephone having a function of reproducing image signals and/or sound signals, corresponding to execution of a karaoke function and/or a game function, comprising conversion means for converting the image signals and/or the sound signals into TV broadcasting signals, and transmission means for transmitting the TV broadcasting signals to a TV receiver.

### BRIEF DESCRIPTION OF THE DRAWINGS

FIG. 1 is a block diagram showing a configuration of a whole system including a first embodiment of a cellular telephone according to the invention;

FIG. 2 is a view showing an example of a makeup of karaoke musical piece data;

FIG. 3 is a block diagram showing an internal configuration of the cellular telephone shown in FIG. 1;

FIG. 4 is a block diagram showing a detailed internal configuration of Video Output Unit 24 shown in FIG. 3;

FIG. 5 is a table showing relationship between an image size and a display screen;

FIG. 6 is a schematic representation illustrating a state where an image of a LCD display size of the cellular telephone is enlarged to the standard television size;

FIG. 7 is a block diagram showing an internal configuration of a second embodiment of a cellular telephone according to the invention;

FIG. 8 is a schematic representation illustrating the operation of the cellular telephones shown in FIG. 7;

FIG. 9 is a block diagram showing an internal configuration of a third embodiment of a cellular telephone according to the invention; and

FIG. 10 is a schematic representation illustrating the operation of the cellular telephones shown in FIG. 9.

### DETAILED DESCRIPTION OF THE PREFERRED EMBODIMENTS

Embodiments of the invention are described in detail hereinafter with reference to the accompanying drawings.

First Embodiment

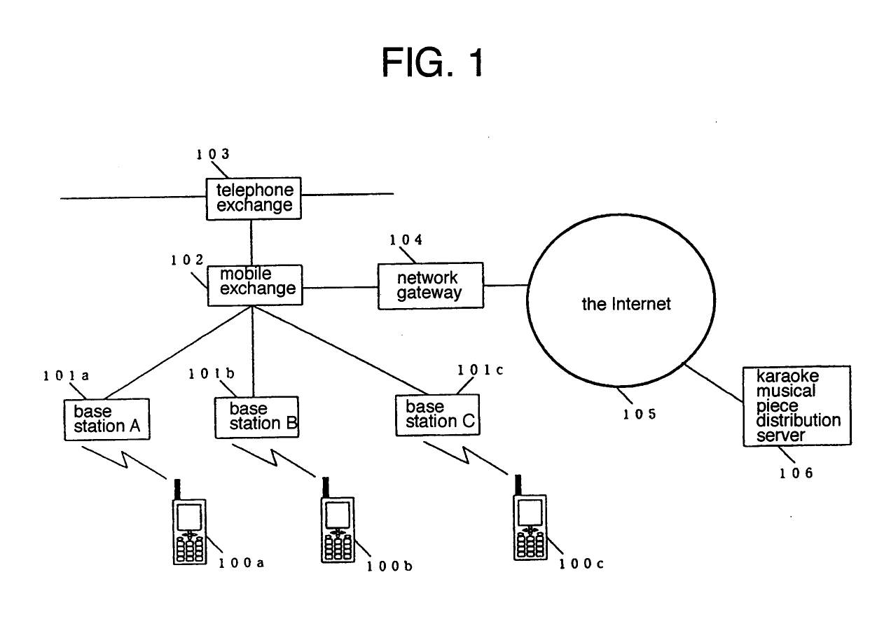

FIG. 1 is a block diagram showing a configuration of a whole system including a first embodiment of a cellular telephone according to the invention. It is assumed that a plurality of cellular telephones 100a to 100c each exist in respective areas where radio communications via each of a plurality of base stations 101a to 101c is possible so as to correspond to the respective areas. As a result, each of the plurality of the cellular telephones 100a to 100c can communicate with each of the plurality of the base stations 101a to 101c. The base stations 101a to 101c are connected with a mobile exchange 102, respectively. A telephone exchange 103 connected with the public network is connected with the mobile exchange 102, and further, a network gateway 104 enabling utilization of Internet connection service by cellular telephones is connected between the mobile exchange 102 and the Internet 105. A karaoke musical piece distribution server 106 is connected with the Internet 105. The karaoke musical piece distribution server 106 provides service enabling musical piece data to be downloaded by the cellular telephones. A normal telephone function is that when, for example, the cellular telephone 100a calls up the cellular telephone 100b, the cellular telephone 100a causes the cellular telephone 100b to receive call-in via the base stations 101a, the mobile exchange 102, and the base stations 101b to establish a call, thereby enabling normal telephone communications to be implemented. Meanwhile, in the case of the cellular telephone 100a downloading karaoke musical piece data, the cellular telephone 100a is connected with the karaoke musical piece distribution server 106 via the base stations 101a, the mobile exchange 102, the network gateway 104, and Internet 105, and can download karaoke musical piece data as desired after designating the same.

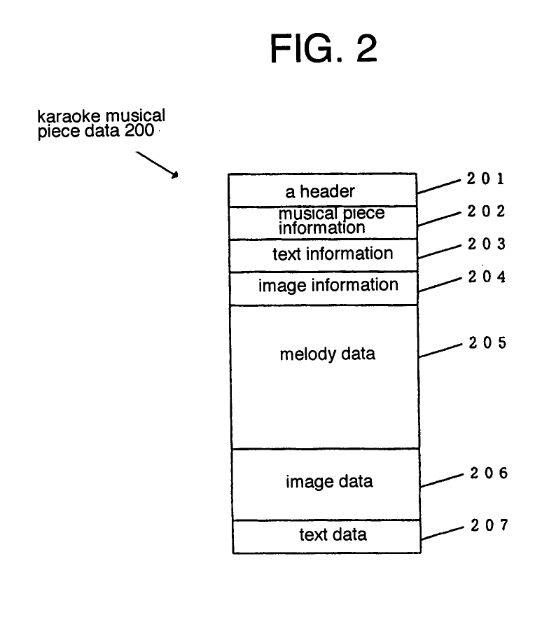

FIG. 2 shows an example of a makeup of karaoke musical piece data 200. The karaoke musical piece data 200 comprises a header 201 for identification of karaoke musical piece data, added to the front thereof, musical piece information 202 concerning musical pieces, such as the titles of musical pieces, composers, songwriters, etc., text information 203 concerning texts, such as languages used in texts, letter codes in use, etc., image information 204 concerning images, such as image compression modes, image display sizes, aspect ratios, etc., melody data 205 following the image information 204, image data 206, and text data 207.

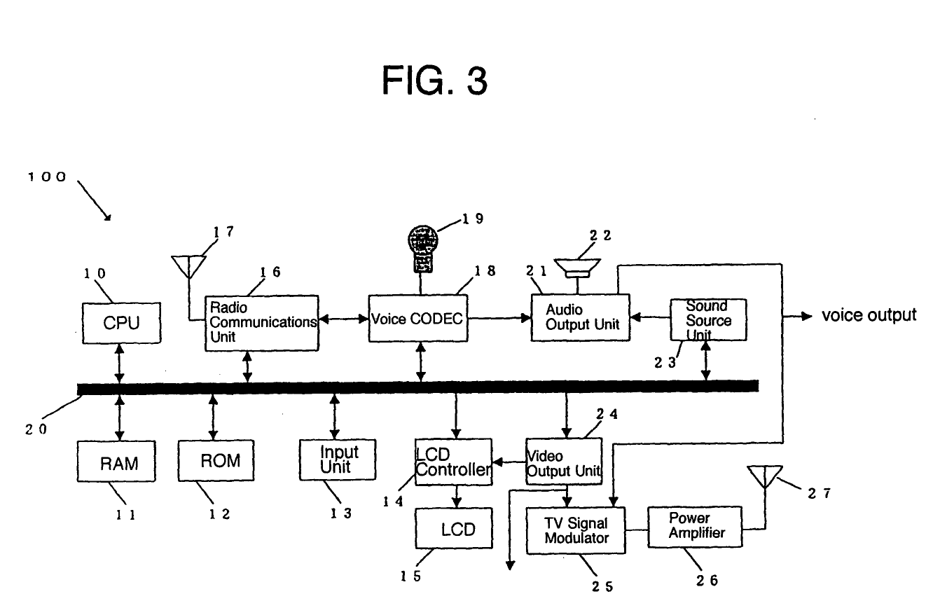

FIG. 3 is a block diagram showing an internal configuration of the cellular telephone 100 shown in FIG. 1. In the figure, CPU 10 is a central processing unit for controlling a cellular telephone 100. RAM 11 is a memory for storing a program under which functions of the cellular telephone 100 are executed under control by CPU10, and is also a memory for storing data temporarily downloaded by a user. ROM 12 is a memory for pre-storing the basic control program (OS) of the cellular telephone and an application program such as a karaoke musical piece reproduction program, and so forth. Input Unit 13 comprises a numeric keypad, control keys, and so forth, fetching data input from a user of the cellular telephone.

LCD Controller 14 is connected with LCD 15 for displaying images and letters, controlling LCD 15. Radio Communications Unit 16 performs radio communications with a base station (not shown) via a radio transmitting and receiving antenna 17. Voice CODEC 18 encodes voice transmitted from a microphone 19, and also decodes signals received by Radio Communications Unit 16, thereby restoring voice signals (also called audio signals). Sound Source Unit 23 reproduces melody data of karaoke musical piece data or call-in melodies as voice signals, outputting the voice signals to Audio Output Unit 21. Audio Output Unit 21, upon receiving the voice signals from Voice CODEC 18 or Sound Source Unit 23, amplifies the voice signals, and emits sound through a speaker 22. Video Output Unit 24 converts images into video signals for television outputting. Data Bus 20 is connected with CPU10, RAM 11, ROM 12, Input Unit 13, LCD Controller 14, Radio Communications Unit 16, Voice CODEC 18, Sound Source Unit 23, and Video Output Unit 24, exchanging data with the respective parts.

TV Signal Modulator 25 modulate the video signals from Video Output Unit 24, and the voice signals from Audio Output Unit 21 so as to suit for television broadcasting, and outputs television broadcasting signals to Power Amplifier 26. Power Amplifier 26 amplifies power of the television broadcasting signals from TV Signal Modulator 25, transmitting the television broadcasting signals towards a television receiver (not shown) via an antenna 27 for television broadcasting radio waves.

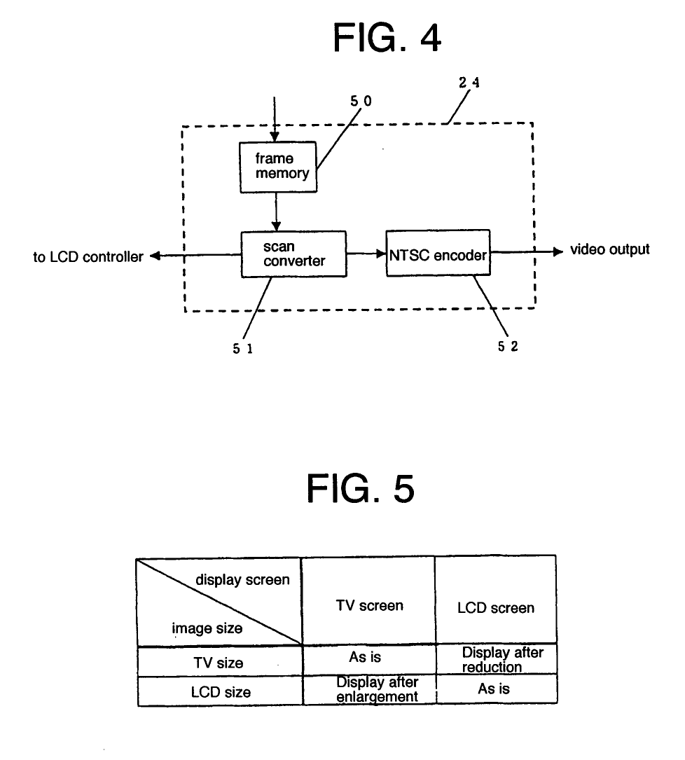

FIG. 4 is a block diagram showing a detailed internal configuration of Video Output Unit 24 shown in FIG. 3. In the figure, a frame memory 50 temporarily stores image data received via Data Bus 20, outputting the image data to a scan converter 51. The scan converter 51 converts the image data from the frame memory 50 so as to correspond to an image display size of the scan converter 51 before outputting. A part of the image data outputted from the scan converter 51 is sent out to LCD Controller 14 for displaying with LCD 15, and the other part of the image data outputted is sent out to an NTSC encoder 52. The NTSC encoder 52 converts the image data outputted from the scan converter 51 into NTSC video signals, which are delivered as video output.

Now, the operation of the cellular telephone according to the first embodiment at the time of reproducing a karaoke musical piece is described hereinafter with reference to FIGS. 1 to 4.

First, musical piece data that is downloaded by the cellular telephone 100 is stored in RAM 11. Upon execution of operation for karaoke musical piece reproduction by manipulating the numeric keypad and control keys of Input Unit 13, CPU 10 executes a call to a karaoke musical piece reproduction program (not shown) from ROM 12. As a result, karaoke musical piece data are read out from RAM 11. The karaoke musical piece reproduction program identifies the header 201 of the karaoke musical piece data as read out, and determines whether or not the karaoke musical piece data is reproducible karaoke musical piece data. Upon determination that the same is the reproducible karaoke musical piece data, the karaoke musical piece reproduction program reads the musical piece information 202, text information 203 and image information 204.

Subsequently, the karaoke musical piece reproduction program sends out melody data 205 comprising notes, tempo, musical instrument information, and so forth, stored in the melody data 205, to Sound Source Unit 23 via Data Bus 20. Sound Source Unit 23 generates voice signals from the melody data 205, and sends out the voice signals to Audio Output Unit 21, thereby emitting music sound through the speaker 22. Further, voice signals taken in from the microphone 19 are sent out to Audio Output Unit 21 via Voice CODEC 18. Audio Output Unit 21 mixes the voice signals from Sound Source Unit 23 with the voice signals from Voice CODEC 18 to thereby emit sound through the speaker 22. In this connection, the voice signals taken in by Voice CODEC 18 are sent out to Audio Output Unit 21 as they are without being processed for encoding.

Next, the karaoke musical piece reproduction program obtains image sizes from the image information 204 of the karaoke musical piece data 200. An image displaying method varies depending on the image sizes. This is because, in contrast with a digital television format in the case of digitizing images of a standard television size such as those according to the NTSC system, predicated on display in large size such as 480i (namely, 480×720 pixels, interlace), the LCD size of the cellular telephone is small, and images as they are cannot be displayed on a television screen. Conversely, the images of the standard television size are large, and consequently, cannot be displayed as they are on the LCD of the cellular telephone. Accordingly, the scan converter 51 inside Video Output Unit 24 converts image sizes. FIG. 5 is a table showing relationship between an image size and a display screen, demonstrating a compatible relationship therebetween, required for conversion of the image sizes. In this connection, conversion from a small image to a large image is referred to as up-scan while conversion from a large image to a small image is referred to as down-scan hereinafter. The table showing the relationship between the image size and the display screen together with the karaoke musical piece reproduction program need to be prestored in ROM 12.

Subsequently, under the control of the karaoke musical piece reproduction program, the scan converter 51 obtains an image size from the image information of the karaoke musical piece data. At this point in time, if the size of image data as stored corresponds to the images of the standard television size, the scan converter 51 sends out the image data of the size as is to the NTSC encoder 52, and down-scans the image data to the LCD display size of the cellular telephone, as shown in Table of FIG. 5, before sending the same out to LCD Controller 14. On the other hand, if the size of the image data as stored corresponds to the images of the LCD display size, the scan converter 51 up-scans the image data and sends the same out to the NTSC encoder while sending out the image data of the LCD display size of the cellular telephone to LCD Controller 14. Texts stored in the karaoke musical piece data 200 are superimposed on image data to produce composite images, thereby being sent out to LCD Controller 14 and Video Output Unit 24.

Meanwhile, under the control of the karaoke musical piece reproduction program, video signals from Video Output Unit 24 and voice signals from Audio Output Unit 21 are sent out to TV Signal Modulator 25 to be modulated into signals for television broadcasting, and the signals are amplified in power by Power Amplifier 26 to thereby emit television signals via the antenna 27. The television signals emitted from the antenna 27 are received by the tuner of a television receiver, whereupon images are displayed on a television screen while a karaoke musical piece is emitted from the speaker of the television receiver.

Further, the video signals delivered from Video Output Unit 24 and the voice signals delivered from Audio Output Unit 21 may be delivered from a video output terminal and a voice output terminal of the cellular telephone, respectively. If these signals are fed to a video input terminal and a voice input terminal of the television receiver, images can be similarly displayed on the television screen, and a karaoke musical piece can be emitted from the speaker of the television receiver.

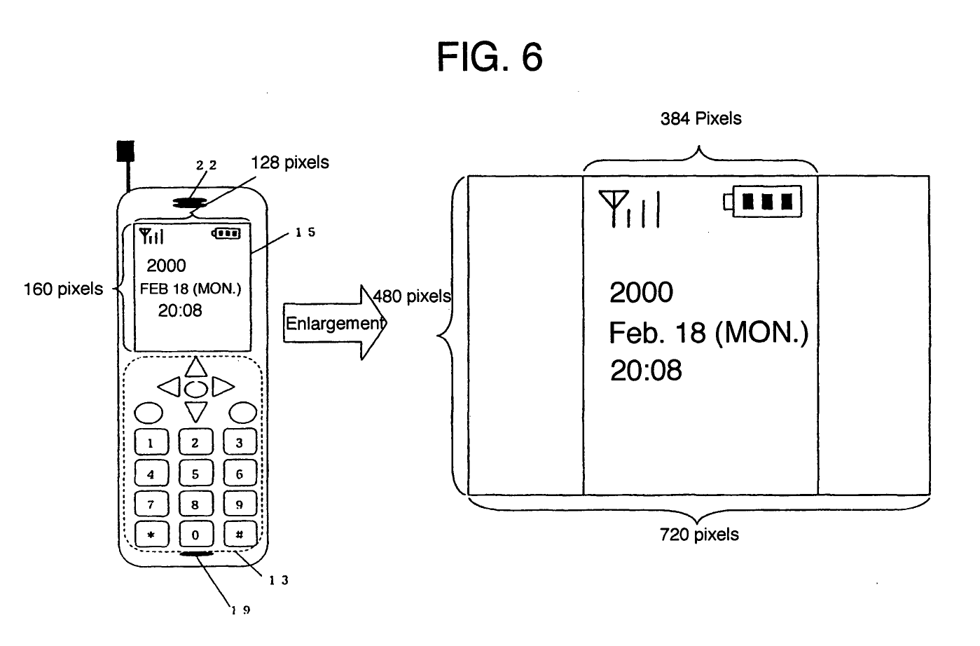

FIG. 6 is a schematic representation illustrating a state where an image of the LCD display size of the cellular telephone 100 is enlarged to the standard television size. In the figure, when the LCD size of the cellular telephone is for 160×128 pixels, the image data of the LCD display size is up-sanned to be expanded to image data incorporating 480×384 pixels. In this way, images can be expanded to be displayed on the television screen.

Thus, with the first embodiment described in the foregoing, images and voice of the karaoke musical piece can be delivered with the television receiver. A user can enjoy playing karaoke music in a large sound volume while watching a large screen. Further, by storing images of the standard television size in the karaoke musical piece data, images of higher quality than the quality of small images of conventional cellular telephones can be watched.

Second Embodiment

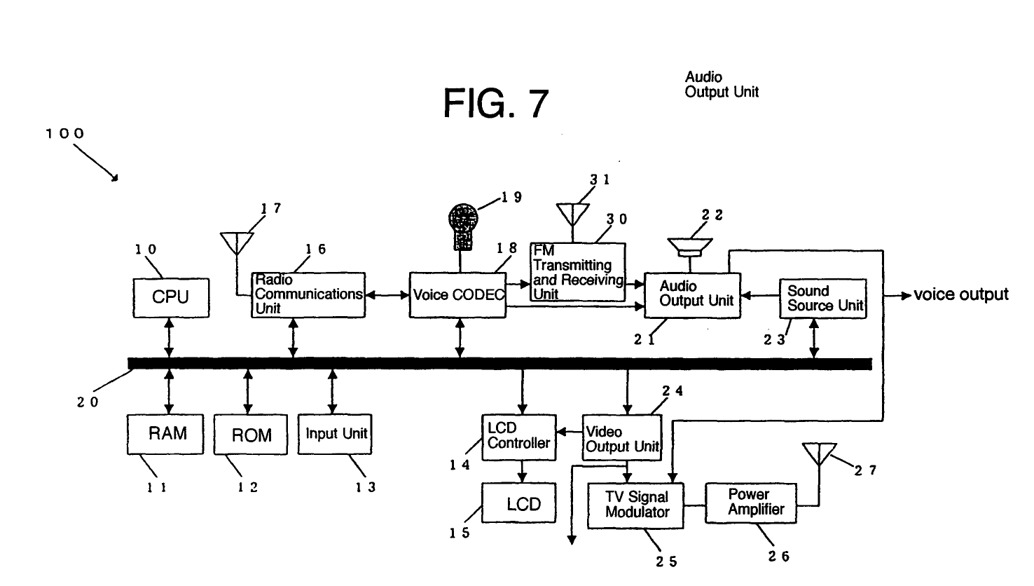

FIG. 7 is a block diagram showing an internal configuration of a second embodiment of a cellular telephone 100 according to the invention. The cellular telephone 100 according to the second embodiment has the internal configuration with an additional function of FM Transmitting and Receiving Unit 30 and an antenna 31, newly added to the internal configuration of the cellular telephone 100 according to the first embodiment. Only the additional function is described hereinafter. In this case, FM Transmitting and Receiving Unit 30 is connected with the antenna 31, transmitting and receiving FM waves within FM broadcast frequency band of, for example, 76 to 90 MHz. Transmitting and Receiving Unit 30 also is connected with Voice CODEC 18 and Audio Output Unit 21, and modulates voice signals from Voice CODEC 18 into FM waves, transmitting the FM waves via the antenna 31, while receiving FM waves via the antenna 31, and outputting such voice signal as received to Audio Output Unit 21.

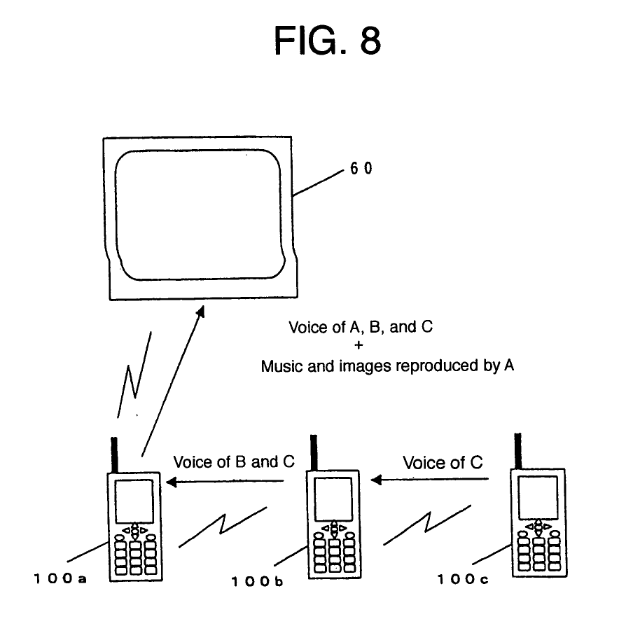

FIG. 8 is a schematic representation illustrating the operation of the cellular telephones shown in FIG. 7. A television receiver 60 is a common type television receiver. The operation of the second embodiment is described hereinafter with reference to FIGS. 7 and 8.

First, a cellular telephone 100c sends out voice inputted from a microphone 19 of the cellular telephone 100c to a cellular telephone 100b via FM Transmitting and Receiving Unit 30 of the cellular telephone 100c. The cellular telephone 100b mixes the voice of the cellular telephone 100c, received by FM Transmitting and Receiving Unit 30 thereof, with the voice inputted from the microphone 19 of the cellular telephone 100c, thereby sending out mixed voice to a cellular telephone 100a via FM Transmitting and Receiving Unit 30 thereof. The cellular telephone 100a mixes the voice of the cellular telephone 100c, received by FM Transmitting and Receiving Unit 30 thereof, the voice of the cellular telephone 100b, voice inputted from a microphone 19 of the cellular telephone 100a, and a karaoke musical piece together. A mixed voice together with images from Video Output Unit 24 are converted into television signals by TV Signal Modulator 25, and the television signals are amplified in power by Power Amplifier 26 to be transmitted to the television receiver 60 via an antenna 27. Now, the operation for the reproduction of karaoke musical pieces is the same as that for the first embodiment, omitting therefore description thereof.

With the second embodiment, karaoke musical pieces can be mixed with a singing voice by sending voice signals in the form of wave to the cellular telephone having the function of karaoke musical piece reproduction. Furthermore, by sequentially sending out respective voices from a plurality of the cellular telephones in relays, a plurality of singing voices can be mixed, thereby enjoying karaoke music. Since all communications among the cellular telephones are performed wirelessly, there is no need for providing troublesome wiring.

Third Embodiment

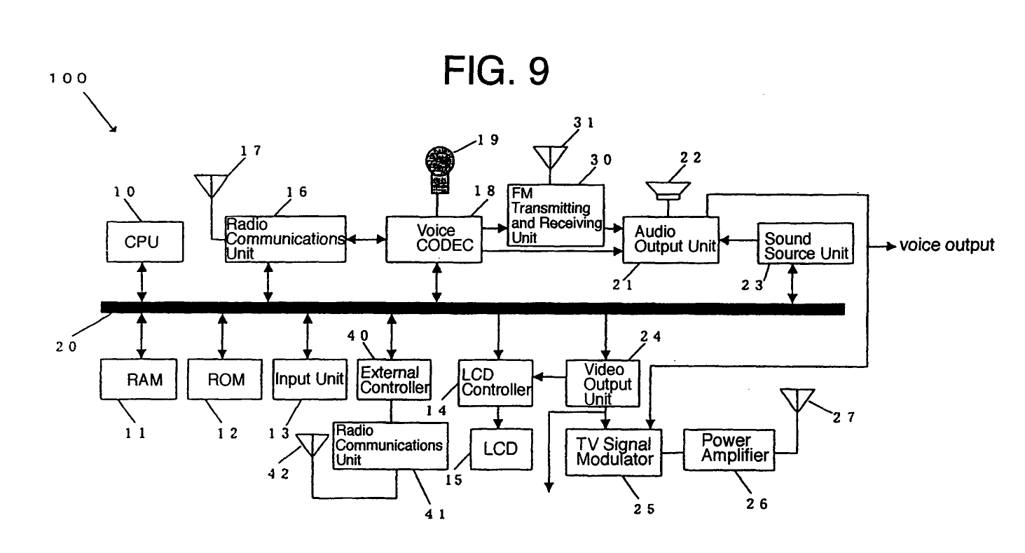

FIG. 9 is a block diagram showing an internal configuration of a third embodiment of a cellular telephone 100 according to the invention. The cellular telephone 100 according to the third embodiment has the internal configuration with additional functions added to that of the cellular telephone 100 according to the second embodiment, omitting therefore description of duplicated parts thereof.

With the third embodiment, there are provided additional functions of External Controller 40, Radio Communications Unit 41, and an antenna 42. As with Input Unit 13, External Controller 40 provides a function of operating the cellular telephone 100 from an external terminal. Radio Communications Unit 41 provides a function of receiving data for External Controller 40. The antenna 42 is connected with Radio Communications Unit 41.

The cellular telephone 100 stores game software besides karaoke musical pieces in RAM 11, enabling CPU 10 to execute the game software and karaoke musical pieces. The game software stored in RAM 11 can be downloaded in the same way in which the karaoke musical pieces are downloaded in the first embodiment. The game software is read out by RAM 11, and is executed by CPU 10 while data for game screens and game sound are sent out to LCD Controller 14, Video Output Unit 24, and Sound Source Unit 23, respectively. As with the first embodiment, if the game screens correspond to a LCD display size, the game screens are up-scanned by a scan converter 51 inside Video Output Unit 24. On the other hand, if the game screens correspond to the television display size, the game screens are down-scanned by the scan converter 51 inside Video Output Unit 24 to be sent out to LCD Controller 14. Output of the scan converter 51 is converted into video signals by the NTSC encoder 52. The data for the game sound is sent out to Sound Source Unit 23, and is converted into voice signals to be sent out to Audio Output Unit 21. The video signals delivered from Video Output Unit 24 and the voice signals delivered from Audio Output Unit 21 are converted into television signals by TV Signal Modulator 25 to be transmitted to a television receiver via the antenna 27.

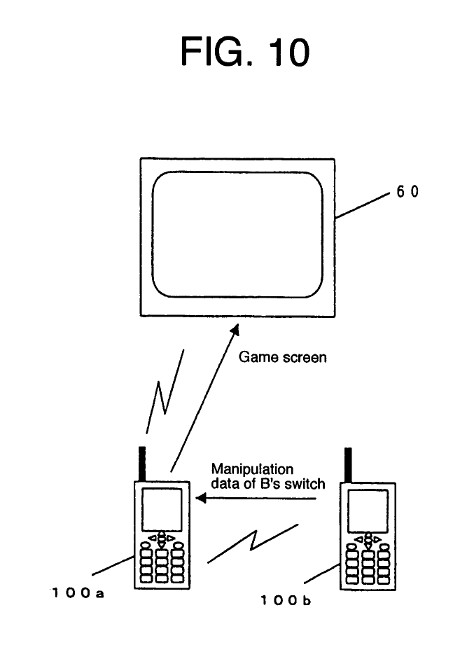

FIG. 10 is a schematic representation illustrating the operation of the cellular telephones shown in FIG. 9. With the present embodiment, cellular telephones 100a, 100b each can play game singly, but also in pairs upon acceptance of the operation by the other cellular telephone. The operation of the third embodiment is described hereinafter with reference to FIGS. 9 and 10.

Description is given hereinafter of a case where a game is played with the cellular telephones 100a, 100b in pairs such that the cellular telephone 100a executes game software, transmitting game screens and game sound to a television receiver while the cellular telephone 100b acts as the other cellular telephone executing the operation of the game from outside. The cellular telephone 100b transmits a request for participation in the game to the cellular telephone 100a in order to participate in the game being operated with the cellular telephone 100a. If the cellular telephone 100a is ready to accept the request for participation in the game, it gives permission for participation to the cellular telephone 100b. The manipulation of a numeric keypad and control keys of the cellular telephone 100b is transmitted from Input Unit 13 to the cellular telephone 100a through External Controller 40 via Radio Communications Unit 41. The cellular telephone 100a inputs manipulation signals for the numeric keypad and control keys of the cellular telephone 100b as received from Radio Communications Unit 41 to External Controller 40 of the cellular telephone 100a. Thereafter, the game software executed by the cellular telephone 100a will be operated in accordance with the manipulation signals of both the cellular telephone 100a and the cellular telephone 100b.

As described hereinbefore, with the third embodiment, game software being operated by one cellular telephone can be manipulated by the other cellular telephone.

As is evident from a plurality of the embodiments of the invention described above, it is possible to cause a television receiver to output karaoke sound or game sound together with karaoke screens or game software screens, operated by a cellular telephone. Thus, users can enjoy the benefits of these add-on functions executed in a large sound volume while watching a large screen. Further, if the karaoke screens or the game software screens correspond to the standard television size, the users can enjoy games with images higher in quality than smaller images of conventional cellular telephones.

In addition, by transmitting the key manipulation of one cellular telephone wirelessly to other cellular telephones where add-on functions, such as game software, and so forth, are in operation, the add-on functions can be concurrently enjoyed by a plurality of cellular telephones.

With reference to the plurality of the embodiments described in the foregoing, there is shown by way of example a case of downloading karaoke musical piece data from a karaoke musical piece distribution server over the Internet as means for obtaining the karaoke musical piece data, however, the karaoke musical piece data may be obtained by other means such as data transfer from other cellular telephones. Further, the NTSC system is shown herein as the format of video signals outputted by the cellular telephones, but other formats of video signals, such as the PAL system, and so forth, may be applicable. Further, the television receiver is not limited to a common television receiver for analog broadcasting, and the invention may be applicable to a television receiver for digital broadcasting provided that it is equipped with a reproduction function capable of reproducing image and sound broadcasting signals. Furthermore, there is shown by way of example a case of playing karaoke music or games with three units of the cellular telephones. It is obvious, however, that karaoke music or games may be played with a plurality of the cellular telephones, not less than three units.

What is claimed is:

1. A cellular telephone comprising:
conversion means for converting the image signals and/or the sound signals into TV broadcasting signals; and
transmission means for transmitting the TV broadcasting signals to a TV receiver,
wherein the cellular telephone has a function of reproducing image signals and/or sound signals, corresponding to execution of a karaoke function and/or a game function.

2. A cellular telephone according to claim 1, wherein the conversion means enlarge or reduce a display size of image data to a display size corresponding to a display screen of the cellular telephone or the TV receiver.

3. A cellular telephone according to claim 2, wherein the conversion means are implemented so as to correspond to information on image display size, contained in software or data, for executing the karaoke function or the game function.

4. A cellular telephone according to claim 1, further comprising means for mixing the sound signals with sound signals received from at least one unit of other cellular telephones.

5. A cellular telephone according to claim 4, further comprising means for transferring sound signals after the mixing to the other cellular telephones.

6. A cellular telephone according to claim 1, further comprising means for inputting manipulation signals received from at least one unit of other cellular telephones in response to the execution of the karaoke function or the game function.

7. A cellular telephone comprising:
a conversion circuit converting the image signals and/or the sound signals into TV broadcasting signals; and
a transmission circuit transmitting the TV broadcasting signals to a TV receiver,
wherein the cellular telephone has a function of reproducing image signals and/or sound signals, corresponding to execution of a karaoke function and/or a game function.

8. A cellular telephone according to claim 7, wherein the conversion circuit enlarges or reduces a display size of image data to a display size corresponding to a display screen of the cellular telephone or the TV receiver.

9. A cellular telephone according to claim 8, wherein the conversion circuit is implemented so as to correspond to information on image display size, contained in software or data, for executing the karaoke function or the game function.

10. A cellular telephone according to claim 7, further comprising a mixing circuit mixing the sound signals with sound signals received from at least one unit of other cellular telephones.

11. A cellular telephone according to claim 10, further comprising a transfer circuit transferring sound signals after the mixing to the other cellular telephones.

12. A cellular telephone according to claim 7, further comprising an input circuit inputting manipulation signals received from at least one unit of other cellular telephones in response to the execution of the karaoke function or the game function.
